(19) United States
(12) Patent Application Publication
(10) Pub. No.: US 2017/0368677 A1
(43) Pub. Date: Dec. 28, 2017

(54) LIGHT FIXTURE ASSEMBLY FOR CREEPER ASSEMBLY

(71) Applicant: HORIZON GLOBAL AMERICAS INC., Plymouth, MI (US)

(72) Inventors: Gregory Y. Rotenberg, Highland Heights, OH (US); Theodore Joseph Siegel, Mayfield Heights, OH (US); Eric Michael Yukich, Stow, OH (US)

(21) Appl. No.: 15/632,616

(22) Filed: Jun. 26, 2017

Related U.S. Application Data
(60) Provisional application No. 62/354,390, filed on Jun. 24, 2016.

(51) Int. Cl. B25H 5/00; F21W 131/402; F21V 33/00

(52) U.S. Cl. CPC B25H 5/00; F21V 33/0084; F21W 2131/402

(57) ABSTRACT

Disclosed is a light assembly that is removably attachable to a work surface such as a creeper assembly. The light assembly may include a light positioned along a top of a dome shaped housing and a base with a plurality of lugs. A pad member may be attached to the work surface and the lugs may be selectively engageable with attachment members extending from the pad member. The attachment member may include a biasing member having a self-locating detent configured to engage with a self-locating recess thereby generally aligning the pad member and the light assembly. The pad member or the base of the light assembly may include a magnet. The light assembly may also include at least one light array about the perimeter of the housing.

### CROSS-REFERENCE TO RELATED APPLICATIONS

This application claims the benefit from Provisional Patent Application No. 62/354,390 entitled “CREEPER ASSEMBLY” filed on Jun. 24, 2016 and is hereby incorporated by reference in its entirety.

### FIELD OF INVENTION

The present disclosure relates generally to a light fixture assembly that includes an attachment assembly for a creeper device, and more particularly, to a light fixture assembly for connection to work surfaces to display light away from the work surface.

### BACKGROUND

Creeper assemblies have been known to greatly facilitate access beneath a motor vehicle or other low-slung mechanical device, for work beneath the machine. Creepers are conventionally constructed as relatively small, thin, generally rectangular platforms having sufficient size to support the back, hips, and head of a supine person lying thereon, with a small roller, caster, or wheel at each corner to minimize ground clearance.

The reason conventional creepers may be impractical is that there exists relatively bad lighting directed beneath the machine storage. As a result, some known creeper assemblies have incorporated light assemblies attached to the body of the creepers. These embodiments are described in U.S. Pat. Nos. 6,540,378; 7,032,908, and 9,126,326 as well as U.S. Patent Publication No. 2011/0227303. However, each of these creeper assemblies include light assemblies that are rigidly attached to a portion of the creeper body. These light assemblies include relatively rigid or bulky armatures or otherwise require impractical power sources, such as being plugged into a power receptacle. These design flaws obviate much of the advantage of providing a light assembly attached to the creeper body. Moreover, the configuration of such creeper light assemblies do not allow room for modifying the position of the supplemental work light source while having practical access and storage to tools, equipment, accessories while maintaining a work position under the machine being maintained.

Therefore, there is a need to provide a creeper assembly and light fixture assembly that can be easily attached. Further, it may be beneficial to provide a light fixture assembly that may provide ease of use, as well as, overcome the ergonomic and functional deficits of known assemblies. There is also a need for providing a light fixture assembly that is easily removable from a work surface.

### SUMMARY

The present disclosure describes a creeper assembly with a light assembly that is removably attachable to a creeper assembly or other work surface. In one embodiment, provided is a creeper assembly that includes a body and a plurality of wheels attached to the body. At least one pad member may be attached to the body, the at least one pad member including at least one attachment member and a light assembly selectively attachable with the at least one pad member. The body may include a plurality of pad members such as four or six. The pad member may include a plurality of attachment members and the light assembly may includes a plurality of lugs wherein the lugs selectively attach to the attachment members. Each attachment member may include an arm and an overhang portion wherein at least one of the attachment members may include a biasing member. The biasing member may be generally continuous with the attachment member. At least one of the pad member and the base may include a magnet to selectively attach the base to the pad member.

In another embodiment, provided is a light assembly to be selectively attached to a pad member. The light assembly may include a dome shaped housing and at least one light disposed within the dome shaped housing. A base may be attached to the dome shaped housing wherein the base may be selectively attachable to a pad member. The base may include a plurality of lugs extending from a perimeter of the base and the plurality of lugs may be selectively attachable with a plurality of attachment members that extend from the pad member. At least one of the attachment members may include a biasing member, wherein the biasing member includes a self-locating detent configured to engage with a self-locating recess thereby generally aligning the pad member and the light assembly. The pad member may include a shaped protrusion configured to be received within an annular recessed portion of the light assembly. At least one of the pad member and the base includes a magnet such that the base may be magnetically attachable to the pad member. The base may include a swivel hook configured to pivot relative the base and be stowed within an annular recessed portion of the base. The pad member may be attachable to a work surface, such as a surface of a creeper assembly or another surface.

In one embodiment, the dome shaped housing includes a lens cover for a hazard warning light wherein the hazard warning light includes a light array positioned along a portion of the perimeter of the dome shaped housing in alignment with the lens cover. The light array includes a viewing angle between about 5 to 20 degrees and more particularly between about 8 to 15 degrees. Further, the at least one light may be positioned along a top of the dome-shaped housing, the dome shaped housing may include a depression that surrounds the at least one light. The at least one light includes a viewing angle between about 120 to 160 degrees and more particularly about 140 degrees from the top of the dome shaped housing.

### BRIEF DESCRIPTION OF THE DRAWINGS

Operation of the present disclosure may be better understood by reference to the detailed description taken in connection with the following illustrations. These appended drawings form part of this specification, and any written information in the drawings should be treated as part of this disclosure. In the same manner, the relative positioning and relationship of the components as shown in these drawings, as well as their function, shape, dimensions, and appearance, may all further inform certain aspects of the present disclosure as if fully rewritten herein. In the drawings:

FIG. 1A is a perspective view of an embodiment of a creeper assembly in accordance with the instant disclosure;

FIG. 1B is a top view of the creeper assembly of FIG. 1A;

FIG. 1C is a side view of the creeper assembly of FIG. 1A;

FIG. 2A is a perspective view of another embodiment of a creeper assembly in accordance with the instant disclosure;

FIG. 2B is a top view of the creeper assembly of FIG. 2A;

FIG. 2C is a side view of the creeper assembly of FIG. 2A;

FIG. 3A is a perspective view of an embodiment of a light assembly in accordance with the instant disclosure;

FIG. 3B is a top view of the light assembly of FIG. 3A;

FIG. 3C is a side view of the light assembly of FIG. 3A;

FIG. 4A is a front perspective view of another embodiment of the light assembly of the instant disclosure;

FIG. 4B is a rear perspective view the light assembly of FIG. 4A;

FIG. 5 is an exploded perspective view of a portion of the creeper assembly and the light assembly of the instant disclosure;

FIG. 6 is a perspective view of embodiments of the light assembly attached to a pad member of the instant disclosure;

FIG. 7A is a top perspective view of an embodiment of the pad member of the instant disclosure;

FIG. 7B is a bottom perspective view of the pad member of FIG. 7A;

FIG. 7C is a top perspective view of an embodiment of the pad member of the instant disclosure;

FIG. 7D is a top perspective view of an embodiment of the pad member of the instant disclosure;

FIG. 7E is a bottom perspective view of an embodiment of the pad member of the instant disclosure;

FIG. 8A is a partial perspective view of embodiments of an attachment portion of the pad member in accordance with the instant disclosure;

FIG. 8B is a partial cross sectional view of the light assembly attached to the pad member in accordance with the instant disclosure;

FIG. 9A is a perspective view of an embodiment of a battery compartment in accordance with the instant disclosure;

FIG. 9B is a perspective view of an embodiment of a printed circuit board (PCB) in accordance with the instant disclosure;

FIG. 9C is a perspective view of an embodiment of a base in accordance with the instant disclosure;

FIG. 10A is a perspective view of an embodiment of the light assembly in accordance with the instant disclosure;

FIG. 10B is a top view of the light assembly of FIG. 10A;

FIG. 10C is a side view of the light assembly of FIG. 10A;

FIG. 11A is a perspective view of an embodiment of the light assembly in accordance with the instant disclosure;

FIG. 11B is a top view of the light assembly of FIG. 11A; and

FIG. 11C is a side view of the light assembly of FIG. 11A.

### DETAILED DESCRIPTION

Reference will now be made in detail to exemplary embodiments of the present disclosure, examples of which are illustrated in the accompanying drawings. It is to be understood that other embodiments may be utilized and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

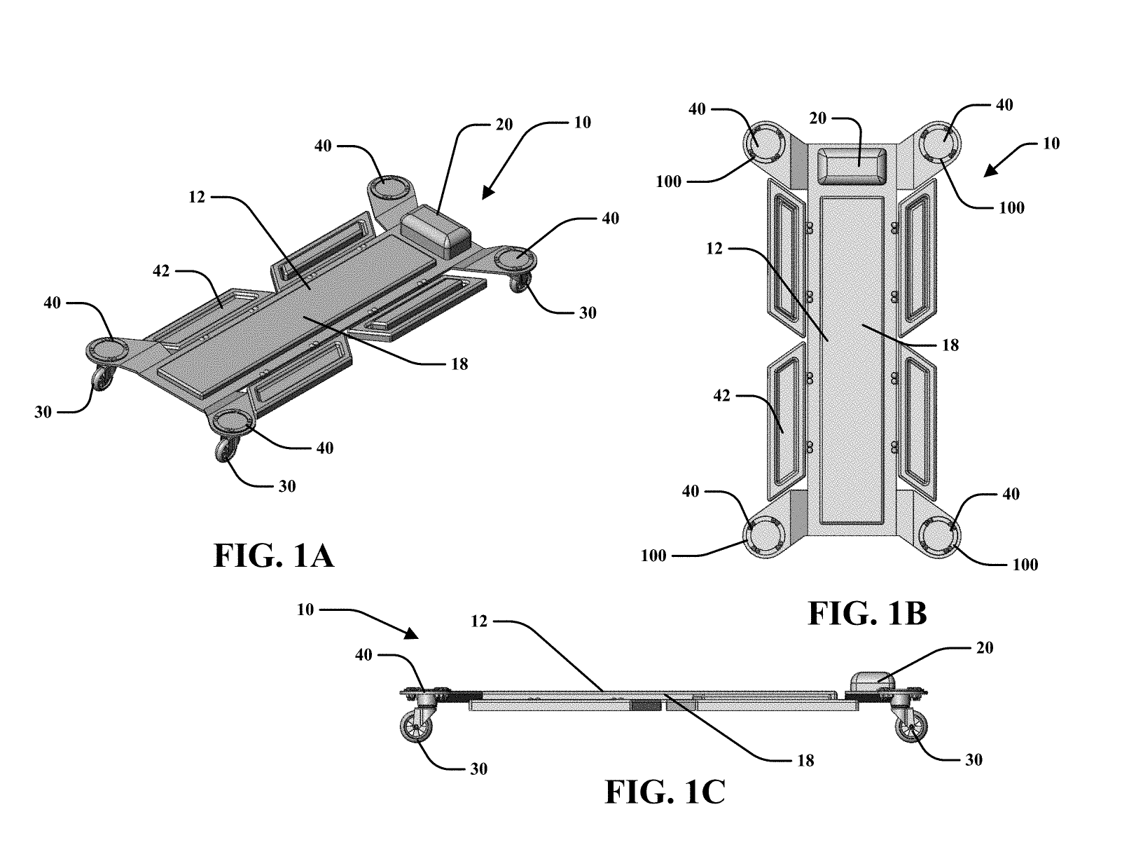

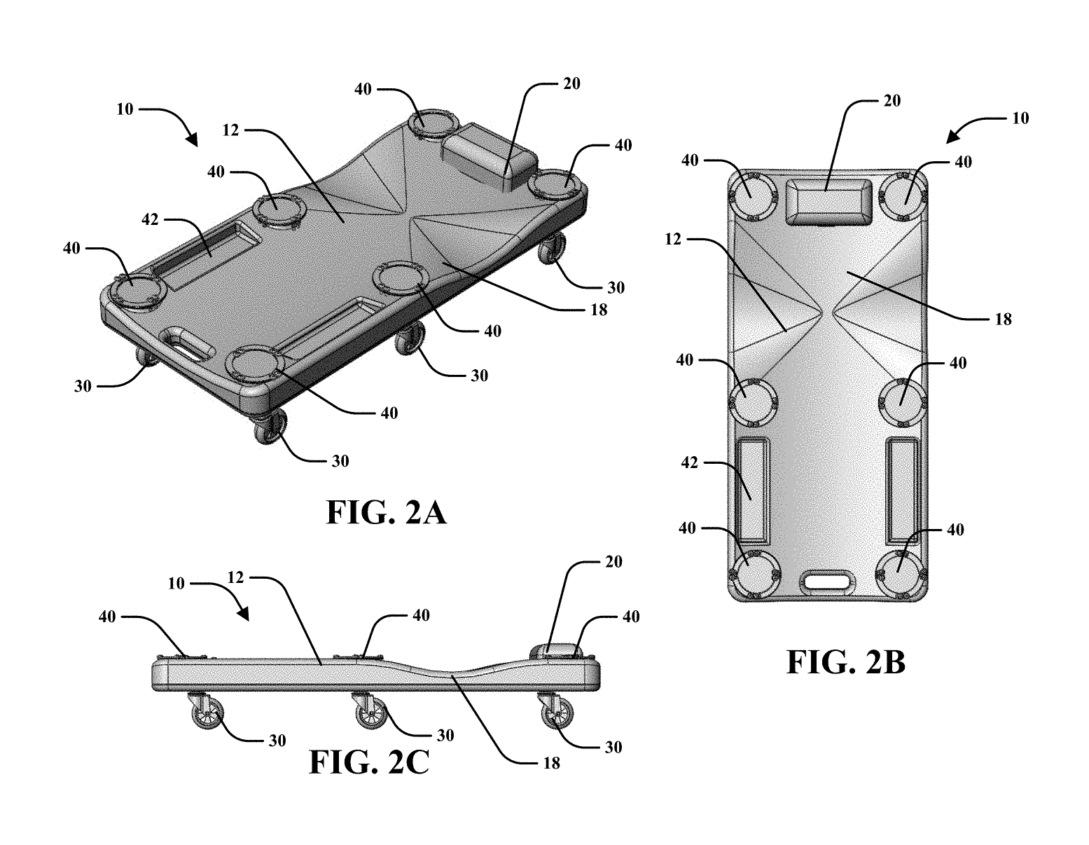

FIGS. 1A, 1B, and 1C illustrate an embodiment of a creeper assembly 10 in accordance with the instant disclosure. FIGS. 2A, 2B, and 2C illustrate another embodiment of the creeper assembly 10 in accordance with the instant disclosure. The creeper assembly 10 includes a body 12. The body 12 may be made of various materials including metal, alloy, polymer, wood or any other material. The creeper assembly 10 may also include various contoured portions along the body 12 including a body support portion 18 and a head support portion 20. In one embodiment, these portions may include a cushion such as a foam or polymer member for added support.

The creeper assembly 10 includes a plurality of wheels 30 such as caster wheels. In one embodiment there are four (4) wheels 30 and in another embodiment there are six (6) wheels. However, this disclosure is not limited to the number or location of the wheels 30 positioned on the creeper 10. The wheels 30 may be attached to the body 12 of the creeper assembly 10 by any suitable means such as fasteners extending through the body 12.

The creeper assembly 10 may include at least one pad member 40 or cradle. In one embodiment, the creeper assembly 10 includes a plurality of pad members 40. The pad member 40 may be positioned along the body 12 of the creeper assembly 10 in alignment with the wheels 30. However, any number and position of pad members 40 are contemplated by this disclosure.

Additionally, the creeper assembly 10 may include one or more tool carriers 42. The tool carriers 42 may extend from the sides of the body 12 of the creeper assembly 10. The tool carriers 42 may be recessed within the body 12.

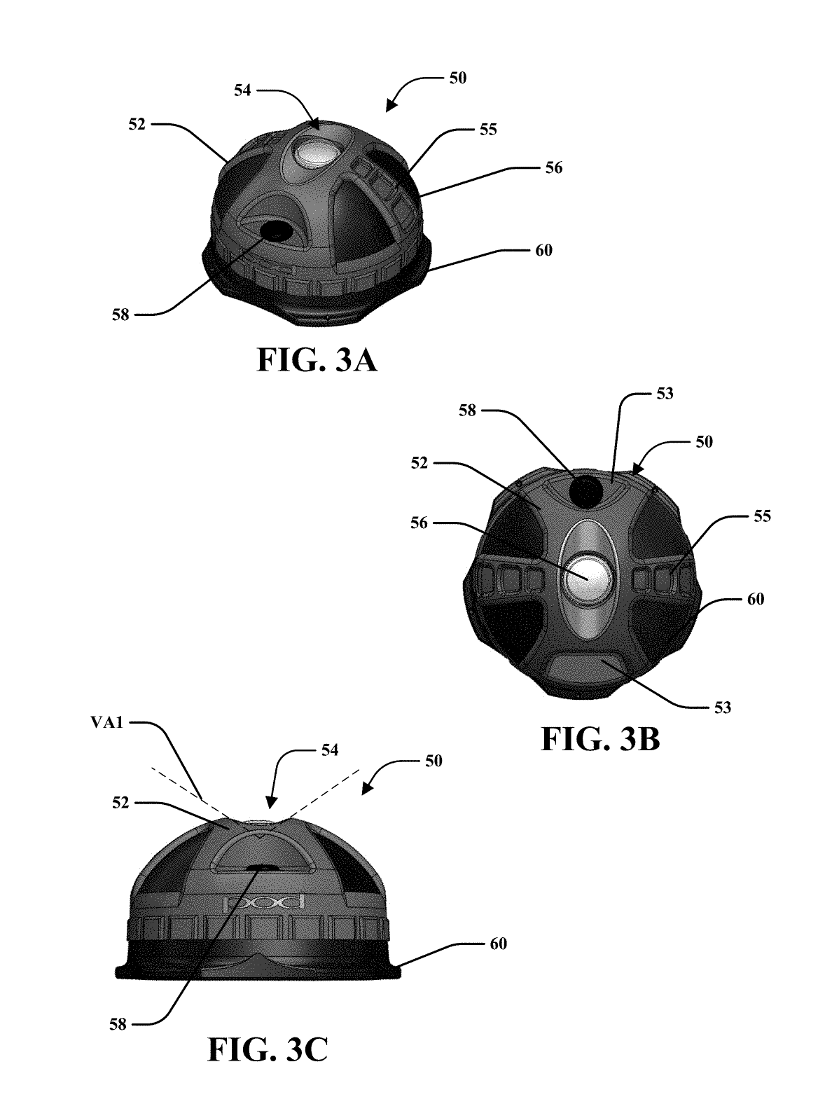

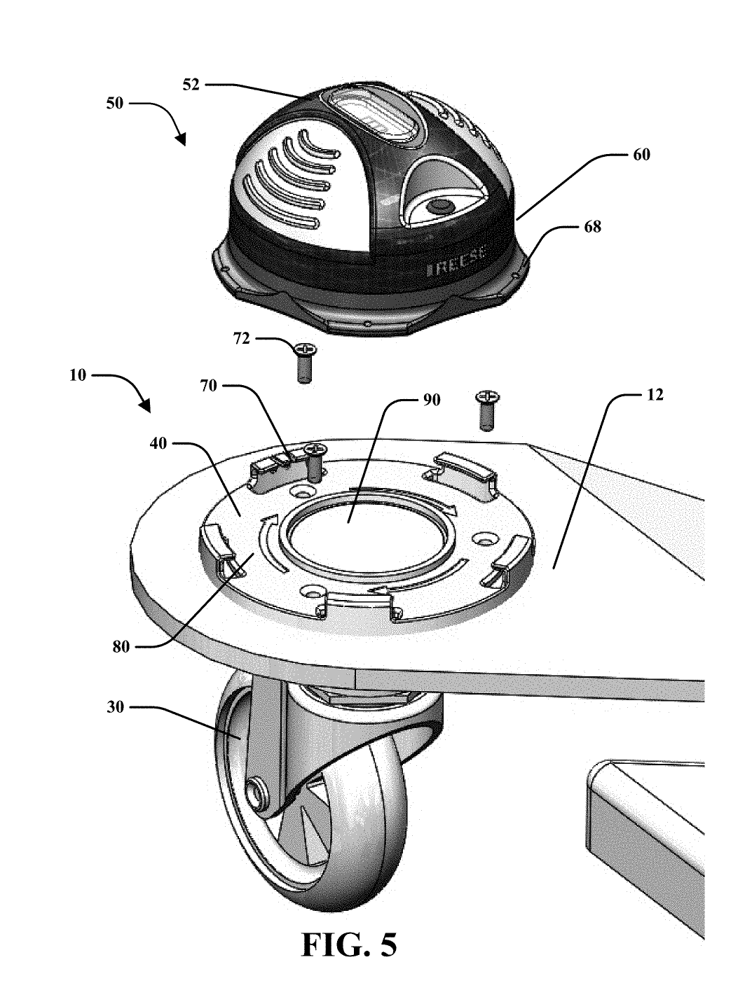

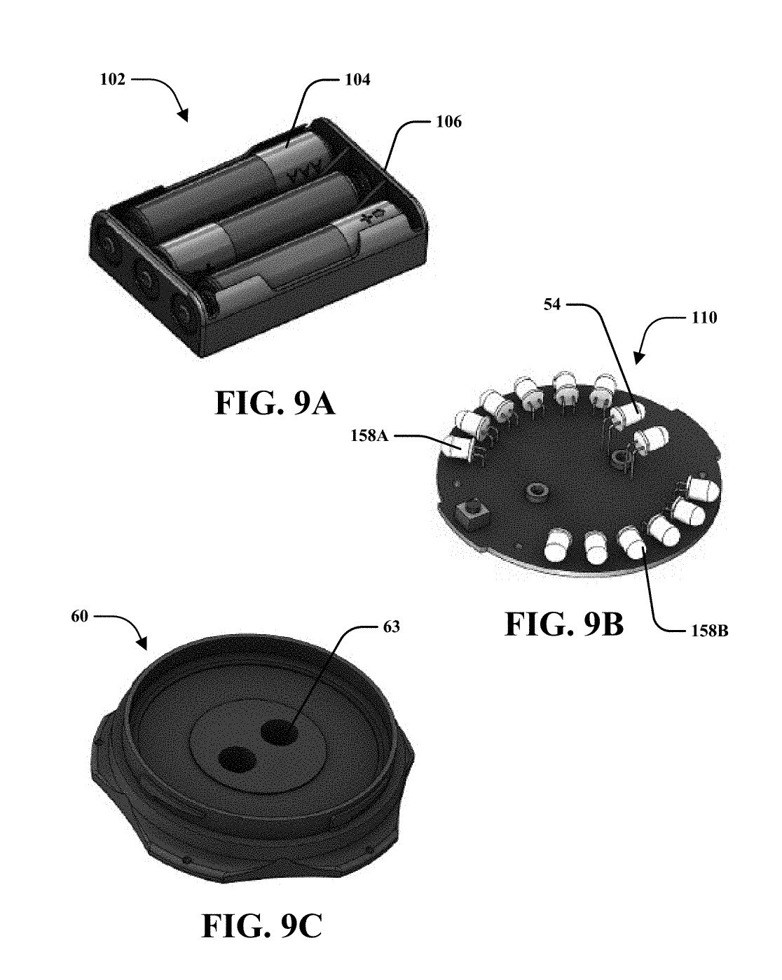

FIGS. 3A, 3B, 3C, 4A, 4B, 11A, 11B, and 11C illustrate various embodiments of a light assembly 50 in accordance with the instant disclosure. The light assembly 50 may be selectively attached to the pad member 40 as illustrated by FIG. 5. The light assembly 50 may include a housing 52 and a base 60. The dome shaped housing 52 may include at least one light 54, at least one lens cover 56, a power supply 102 (shown in FIG. 9A) for powering the light assembly and a switch 58 for toggling power to the light assembly 50.

The housing 52 may be dome shaped. By way of a non-limiting example, the housing may be a solid shell with a texture and/or a color. The housing 52 may be made of a weather, ultra violet (UV) and/or shatter resistant polymer such as ABS and polycarbonate and/or with IP-67 rating. The housing 52 may have a gripping surface 55 thereon having an ornamental shape made with precision molding contours thereon. The gripping surface of the housing 52 may be externally facing to allow a user to grasp the dome shaped housing and rotate it relative to the pad member 40. The gripping surface may be made by over molding including insert molding, double shot molding, co-injection molding as well as hot stamping for a decorative finish and sonic welding for attachment of various features. However, the housing 52 may be made of any appropriate materials and colors and this disclosure is not limited in this regard. The switch 58 may be positioned along a ledge or a shoulder 53 positioned along the perimeter of the dome shaped housing and be generally adjacent to the light 54. In one embodiment, the housing 52 includes opposite facing ledges wherein one of the ledges includes the switch 58. The ledges 53 may be recessed from the gripping surface 55 to ensure that the switch is not toggled by accident.

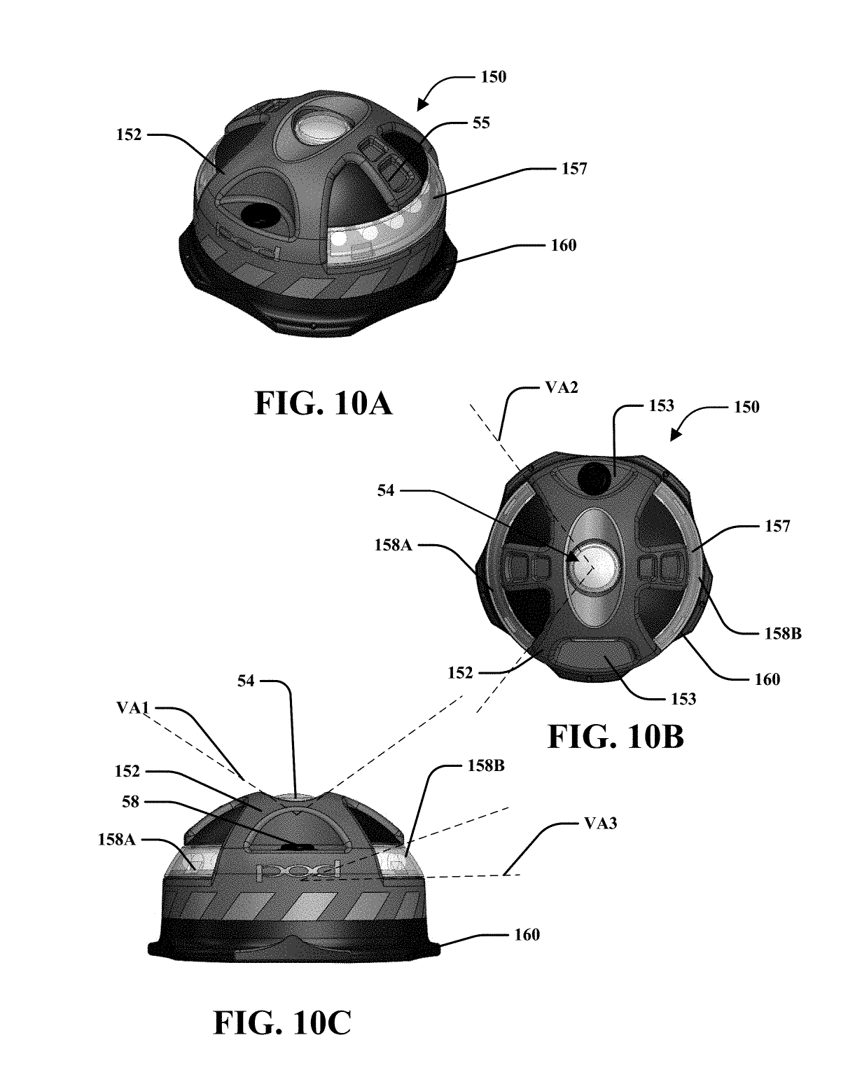

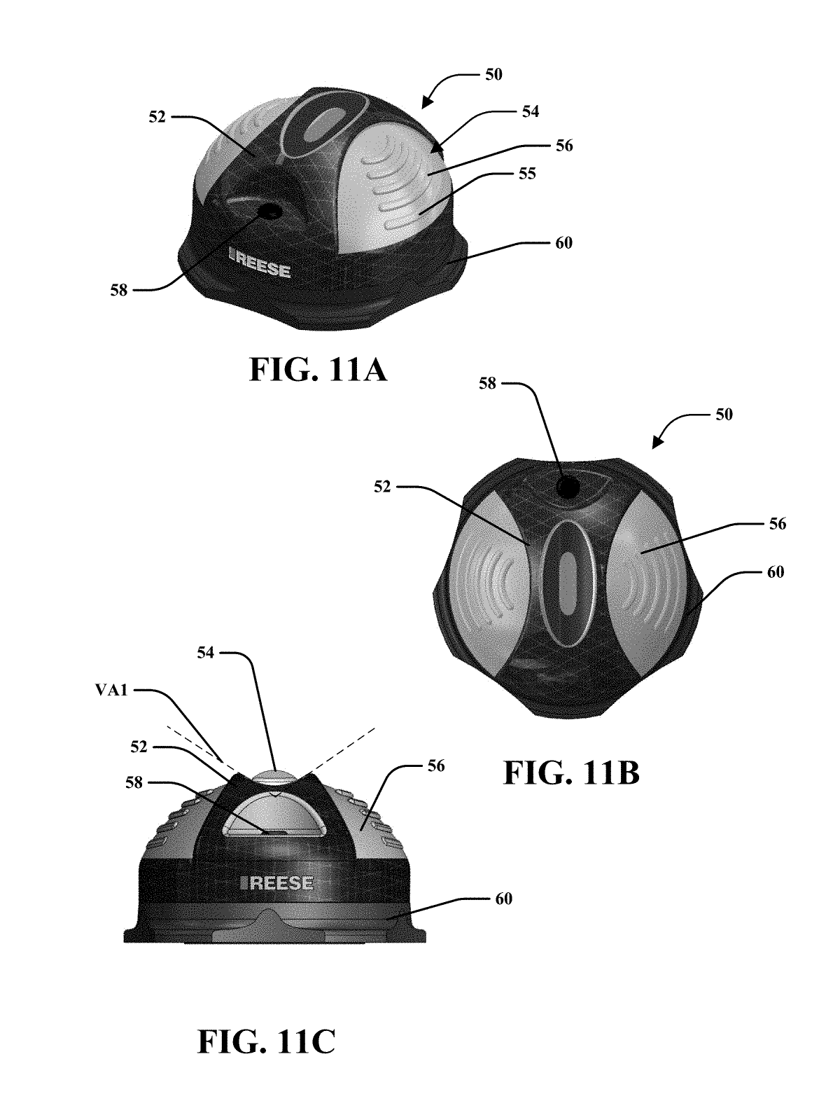

The light 54 may be positioned along the top of the housing 52 and have a viewing angle that distributes light upwardly away from the base 60. In another embodiment, the light 54 may be positioned along a depression 61 along a top of the housing. The depression 61 may be generally slight and have a generally oblong or oval shape and allow for the viewing angle of the light to be directed upwardly and with a desired angle away from the base 60 of the housing 52. The shape of the depression 61 includes a perimeter that surrounds the lens cover 56 along the top of the housing 50 and includes a reflective layer or color that provides reflection or illumination of the light. The light 54 may be positioned along the top of the housing 52 and within the depression 61 may have a viewing angle VA1 that distributes light between about 100 to 160 degrees and more particularly about 140 degrees directed upwardly and away from the base 60. This viewing angle VA1 may be measured from the base of the depression as illustrated by FIGS. 10C and 11C. The remaining surface of the light assembly 50 may be opaque or translucent and have various ornamental features along the surface of the dome shaped housing. The surface may be easily gripped by a user to rotate the light assembly to attach or detach the light as will be discussed below.

The light 54 may be an LED type light, but other light types may be used. By way of non-limiting example, the light may include a chip-on-board (COB) LED type light. The COB LED may be round and include a viewing angle of 140 degrees, light-emitting area of 16 mm in diameter, 3 watt in power, 0.1 ampere in current, 4.5 Volt, 220-240 lm in luminous flux, and with a cool white color. While the specific specifications are provided for the light source above, these are merely exemplary embodiments and that the present system may utilize any appropriate configuration of a light source or any lighting device for that matter. Further, depending upon the application of the present system, specific capabilities of the light source may be required. These various configurations are contemplated by the present disclosure.

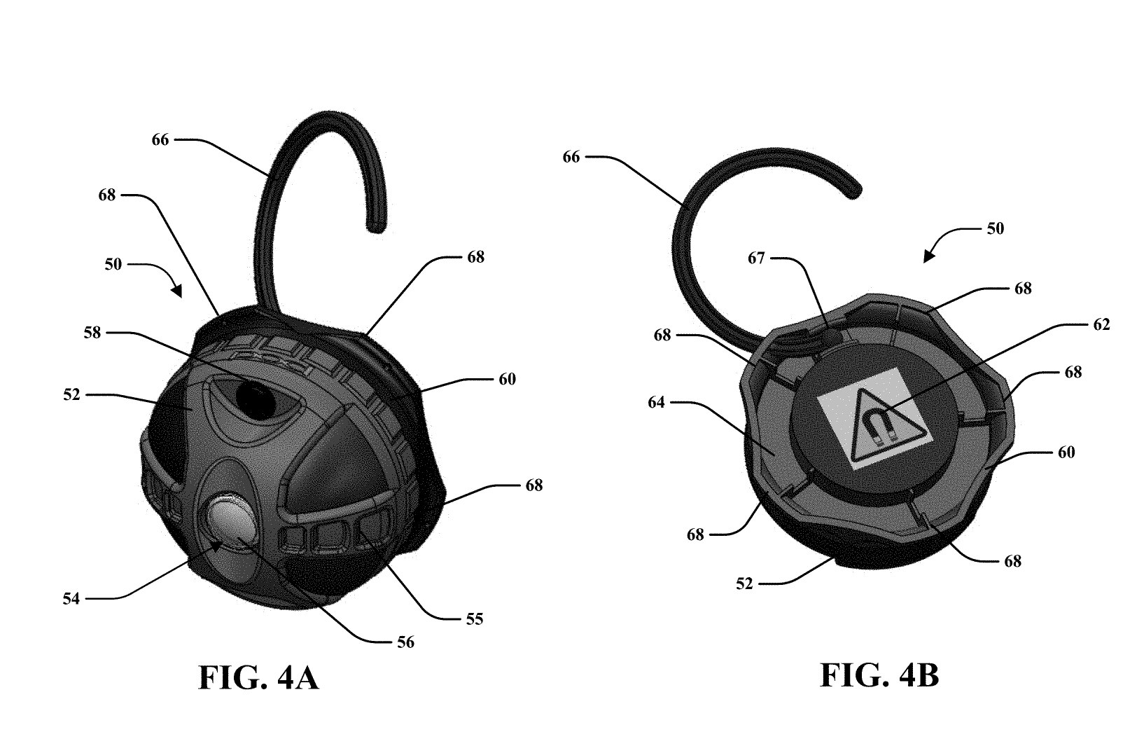

Referring to FIG. 4A, the base 60 may include a shape that corresponds with the shape of the pad member 40. In one embodiment, the base 60 may be a generally circular shape. However, this disclosure is not limited as the shape of the base may be generally complementary to the shape of the pad member 40. The light assembly 50 may be selectively attached to the pad members 40 as they are positioned along the body 12 of the creeper assembly 10.

Referring to FIG. 4B, the base 60 may further include at least one magnet 62 positioned on the underside of the light assembly 50. The at least one magnet 62 may include various magnetic types and may be a neodymium disc magnet 63 (shown in FIG. 9C) with ⅜ inch diameter, ¼ inch thick. A recessed portion 64 may generally surround the magnet 62 within the base 60. The recessed portion 64 may be generally annular.

A hook member 66 shown in FIGS. 4A and 4B may extend from the base 60 of the light assembly 50 and be configured to be stowed within the recessed portion 64 when not in use. The recessed portion 64 may have various shapes and is not limited to being generally annular. The hook member 66 may allow a user to place the light assembly 50 along various articles for support thereon. In particular, the hook member 66 may be placed along portions of the underside of a machine/vehicle or as needed by the user. The hook member 66 may further pivot about a swivel end 67. The magnet 62 may allow the user to also magnetically attach the light assembly 50 along various portions of the machine/vehicle or also to be selectively engaged with the at least one pad member 40 as will be described more fully below.

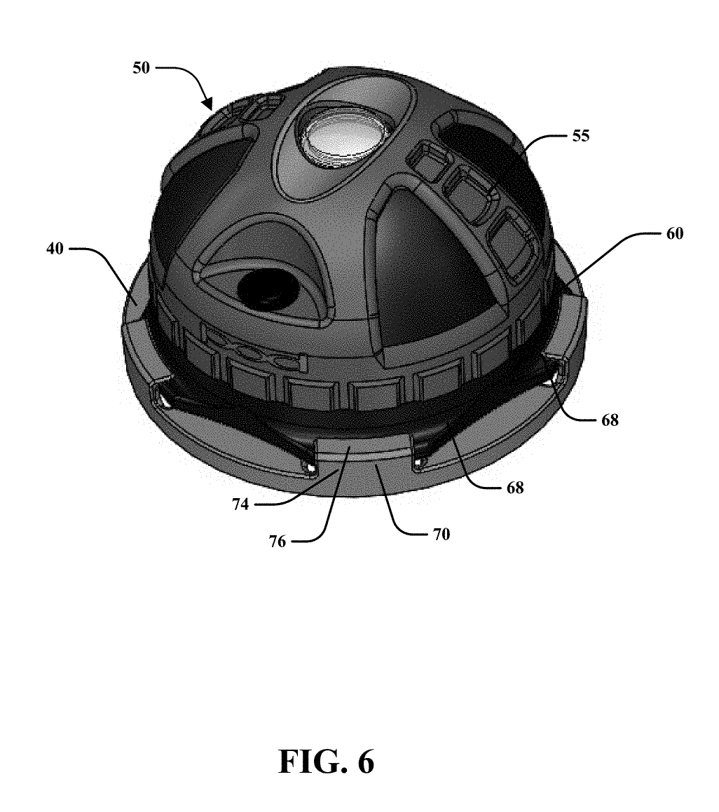

The light assembly 50 maybe be selectively attached to the pad member 40. The selective attachment of the base 60 to the pad member 40 may provide the user tactile feedback to ensure that the light assembly 50 has been secured to the creeper assembly 10 in the desired position. In one embodiment, as illustrated by FIG. 5-8B, the base 60 may include a plurality of perimeter lugs 68 that extend from a perimeter of the base 60 that may be selectively attached with an engagement member 70 that extends from a top surface of the pad member 40. FIG. 5 illustrates the light assembly 50 may be attachable to a work surface such as, for example, on the creeper assembly 10. The pad member 40 may be attached to the work surface 12 with conventional fasteners 72.

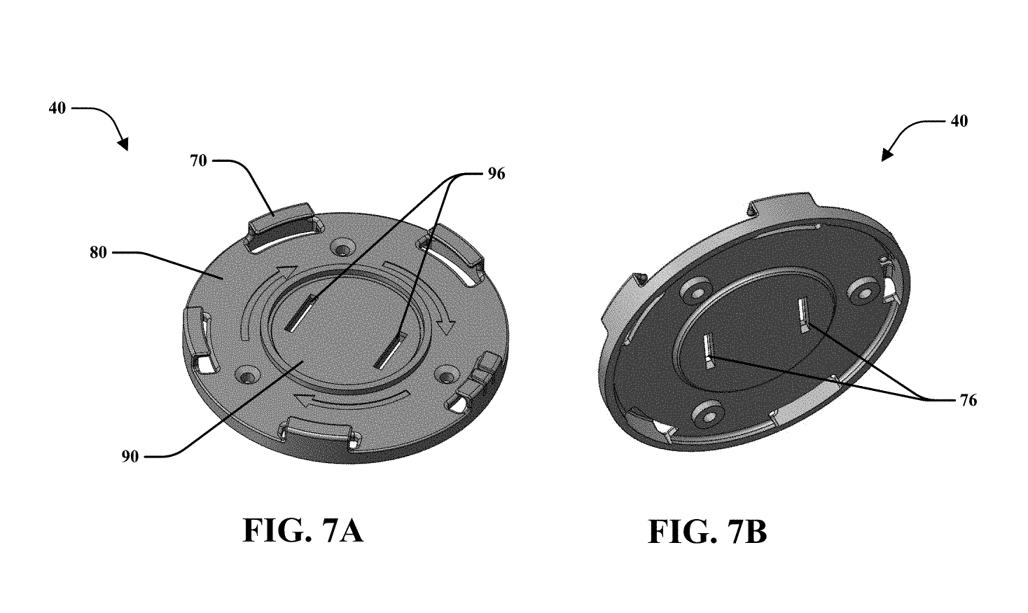

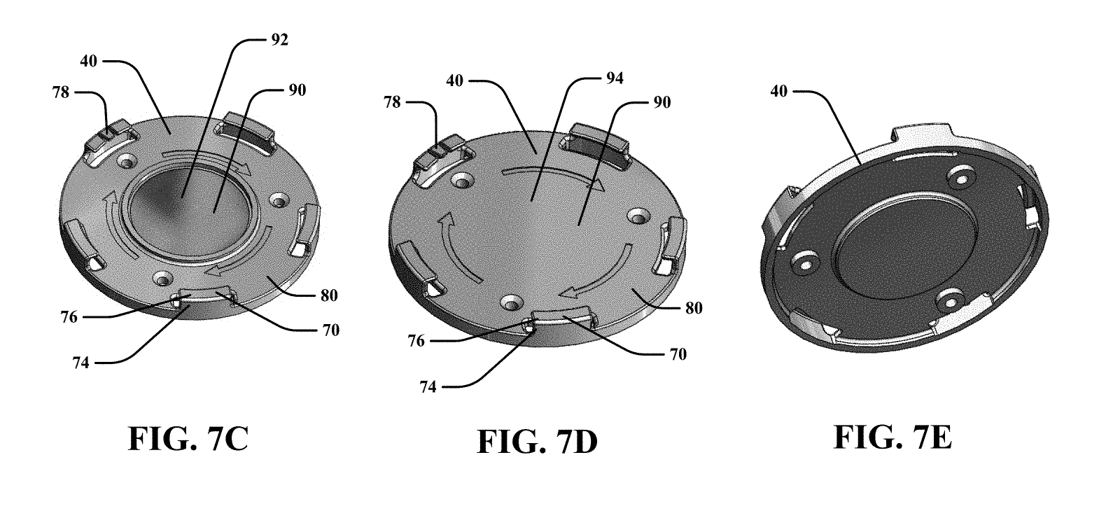

As illustrated by FIGS. 7A and 7B, the pad member 40 may include a perimeter portion 80 and an interior portion 90. The perimeter portion 80 may include the at least one attachment member 70 extending therefrom. The perimeter portion 80 generally surrounds the interior portion 90. The pad member 40 may further include at least one slot 96. The slot may be positioned along the interior portion 90 for allowing a fastening strap (not shown) to pass there through. The fastening strap may be made of a rubber, a leather and hook and loop fastener material allowing for convenient engagement to the work surface.

Referring to FIGS. 7C and 7D, the interior portion 90 may include a generally magnetic surface 92. However, the interior portion may also include a generally non-magnetic surface 94.

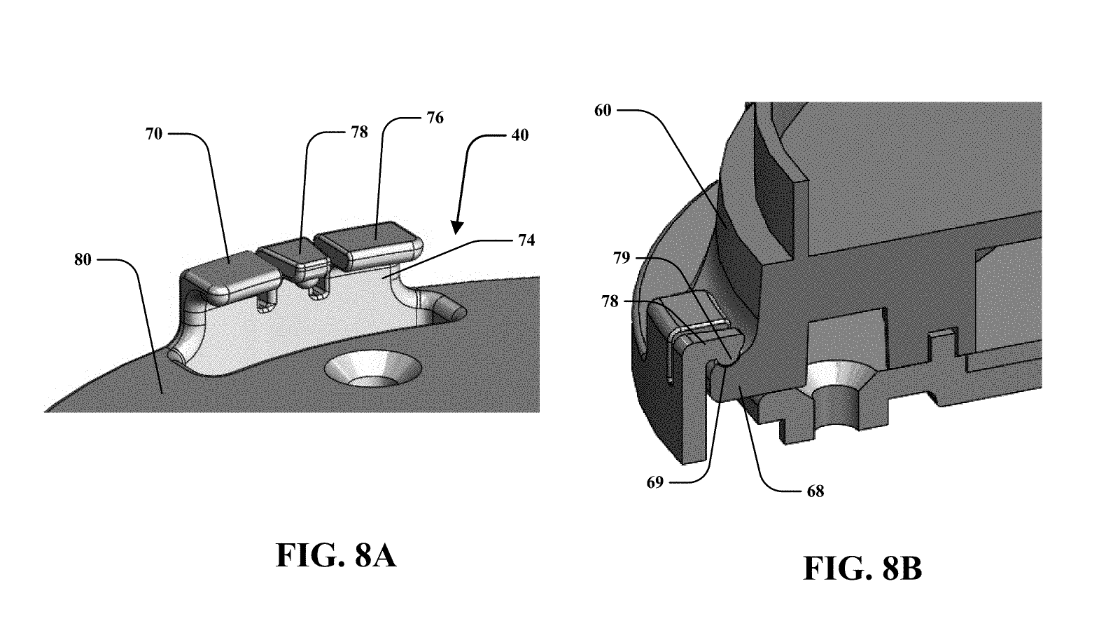

In one embodiment, a plurality of attachment members 70 may generally align with the a plurality of perimeter lugs 68 that extend from the base 60 of the light assembly 50. As illustrated by FIGS. 7C, 7D and 7E, the attachment member 70 may include an arm 74 and an overhang 76. The arm 74 may extend upwardly from a top surface of the pad member 40 and the overhang 76 may extend inwardly from the arm 74. The profile of the arm 74 and overhang 76 may allow each of the lugs 68 of the light assembly 50 to be placed within spaces between the plurality of attachment members 70 and rotated such that the lugs 68 become positioned in alignment with the arms 74 and overhangs 76. In one embodiment, one of the attachment members 70 may include a biasing member 78. The biasing member 78 may be generally continuous with the arm 74 and overhang 76. The biasing member 78 may include a self-locating detent 79 and the lug 68 may include a self-locating recess 69 (See FIG. 8B). The biasing member 78 may engage with the lug 68 such that it may provide tactile feedback when the light assembly 50 is selectively attached or detached from the pad member 40. See FIGS. 8A and 8B. The tactile feedback may be audible in the form of a click or snap sound as well as providing a subtle click or snap that may be felt by the user as the light assembly is secured to the pad member.

In one embodiment, there may be five (5) lugs 68 positioned about the perimeter of the base 60 and there may be five (5) attachment members 70 positioned about the perimeter of the pad member 40. The lugs 68 may be sized to be aligned with the spaces between the attachment members 50 and to slidably rotate relative to the pad member 40 to position a top surface of each of the lugs 68 within the arm 74 and overhang 76 simultaneously.

Further, the magnet 62 positioned on the underside of the light assembly 50 may engage with the interior portion 90 of the at least one pad member. As the magnet 62 engages with the interior portion of the pad member, the user may feel a tactical feedback identifying that the light assembly has magnetically attached to the pad member 40. This configuration may be used with or without attachment members 70.

Alternatively, the attachment member 70 of the pad member 40 may include a shaped protrusion 100 (See FIG. 1B). The shaped protrusion 100 may generally surround the perimeter of the at least one pad member 40 and be configured to be received within the recessed portion 64 of the light assembly 50. The shaped protrusion 100 may have a generally continuous annular shape that is raised from the at least one pad member 40 such that a user could position the light assembly 50 upon the pad member 40 to allow the shaped protrusion 100 be received within the recessed portion 64 (FIG. 4B) while the magnet 62 magnetically attaches to the interior portion 90 of the pad member 40. Notably, this configuration could also provide tactile feedback and easily allow a user to position the light assembly at various pad members 40 positioned along the creeper assembly 10.

With respect to FIGS. 9A, 9B and 9C, the light assembly 50 may include the power supply 102. The power supply 102 for the light assembly 50 may include at least one battery 104 housed within a battery compartment 106. The battery 104 may be preferably of “AAA” type that provides a nominal voltage of 1.5 volts. However, by increasing the diameter of the battery compartment, another type/size may be used. The light assembly 50 may further include a printed circuit board (PCB) 110. The PCB 110 may be preferably of a design to provide 100% ON light output up to 3 hours and 50% ON light output up to 6 hours.

Referring to FIGS. 10A, 10B and 10C, provided is another embodiment of the light assembly 150. This embodiment may further include a hazard warning housing 152 that includes a lens cover 157 and a light array 158. The light array 158 may be in addition to the light 54 and may be positioned about the perimeter of the housing and be generally aligned with the lens cover 157 to provide light therethrough. The light array 158 may include various light sources including a 5 mm red LED-630 nm-T1 ¾ LED type light. By way of a non-limiting example, the 5 mm red LED may include a viewing angle of 8-15 degree through the lens 160 and have a light-emitting area of 16 mm in diameter. These are merely exemplary embodiments and that the present assembly may utilize any appropriate configuration of a light source or any lighting device for that matter. Further, depending upon the application of the present system, specific capabilities of the light source may be required. These various configurations may be contemplated by the present disclosure. As illustrated by FIG. 10B, the light array 158 includes first light array 158A and second light array 158B. The first light array 158A is positioned about a perimeter of the PCB 110 such that the hazard warning housing 152 includes a first facing hazard warning light distributed by the first light array 158A and a second facing hazard waring light distributed by the second light array 158B. The second light array 158B directed opposite from the first light array 158A while the light 54 may be directed upwardly. The first and second light arrays 158A, 158B being positioned along opposite sides of the perimeter of the housing 152 and includes a generally curved shaped. Spaced between the light arrays 158A, 158B include surfaces having shoulders or ledges 153 thereon wherein one of the ledges includes the light switch 58 for toggling power to the light assembly 150. As illustrated by FIG. 10B, the light arrays 158A and 158B may extend about a portion of opposing sides of the perimeter of the dome shaped housing 152. The light arrays may extend a similar viewing angle VA2 extending outwardly from the perimeter in relation to a central axis as viewed from above. The viewing angle VA2 may be between about 80 degrees to about 120 degrees from a central axis and more particularly may be about 100 degrees. As illustrated by FIG. 10C, the light arrays 158A and 158B may extend along a common plane from one another directed in opposing sides of the perimeter of the dome shaped housing 152. The light arrays may extend a similar viewing angle VA3 extending outwardly from the perimeter in relation to a plane generally parallel to the base or ground wherein the viewing angle VA3 relative to a base plane may be between about 5 degrees to about 20 degrees and more particularly may be about 8 to 15 degrees.

The hazard warning housing 152 may further include the PCB 110 and circuitry that may support following operating modes in which the light 54 and/or light array 158 of the light assemblies may be toggled with various manners. These modes include:
ON-100% (COB LED) up to 3 hrs.
ON-50% (COB LED) up to 5 hrs.
OFF everything
Red Double-Blink up to 9 hrs.
Red Double-Pulse up to 9 hrs.
Red Single-Blink up to 36 hrs.
Red Rotate-Beacon up to 9 hrs.
SOS rescue (Morse code) up to 15 hrs.
Red Alternate up to 9 hrs.
2 Red LED single blink up to 40 hrs.

This disclosure provides a compact, adjustable, easily attachable/detachable light assembly to a work surface such as on the body of the creeper assembly. However, other assemblies could also be utilized to attach to the creeper body and this disclosure is not limited to just light assemblies. Containers or tools may be adapted to fit the disclosed pad members to provide a convenient work environment for a user, and in particular, when the work environment is under a machine or vehicle or around the shop or garage. The light assembly may provide sufficient work lighting directed at the work area without being in the way of the user while allowing the user to move freely. Further, the light arrays may provide sufficient lighting to others signaling that a worker is under a vehicle or within a confined work space while also providing work lighting for the worker. Additional flexibility is provided due to the particular configuration of the light assembly. The light assembly may be attached to any ferrous surface via the magnet or any other member via the folding hook. The pad member may also provide a magnet for the retention of small tools and work pieces as well as the selectively engaging of the light assembly. The at least one pad member may also allow the light assembly to be rotated 360 degrees to redirect light in a particular manner. The pad member may be constructed from durable plastic, but this disclosure is not limited to the materials.

Although the embodiments of the present disclosure have been illustrated in the accompanying drawings and described in the foregoing detailed description, it is to be understood that the present disclosure is not to be limited to just the embodiments disclosed, but that the present disclosure described herein is capable of numerous rearrangements, modifications and substitutions without departing from the scope of the claims hereafter. The claims as follows are intended to include all modifications and alterations insofar as they come within the scope of the claims or the equivalent thereof.

Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A light assembly to be selectively attached to a pad member comprising:
a dome shaped housing;
at least one light disposed within the dome shaped housing, the at least one light is positioned along a top of the dome shaped housing, the dome shaped housing includes a depression that surrounds the at least one light; and
a base attached to the dome shaped housing, the base selectively attachable to a pad member, wherein the base includes a plurality of lugs extending from a perimeter of the base and the plurality of lugs are selectively attachable with a plurality of attachment members that extend from the pad member.

2. The light assembly according to claim 1, wherein the pad member includes five attachment members and the light assembly includes five lugs wherein the lugs selectively attach to the attachment members.

3. The light assembly according to claim 1, wherein the attachment member includes an arm and an overhang portion.

4. The light assembly according to claim 3, wherein the attachment member includes a biasing member.

5. The light assembly according to claim 4, wherein the biasing member is generally continuous with the attachment member.

6. The light assembly according to claim 1, wherein the pad member includes at least one magnet.

7. The light assembly according to claim 1, wherein the base includes a swivel hook configured to pivot relative the base and be stowed within an annular recessed portion of the base.

8. The light assembly according to claim 1, wherein the dome shaped housing includes a lens cover for a hazard warning light wherein the hazard warning light includes a first light array positioned along a portion of the perimeter of the dome shaped housing in alignment with the lens cover and a second light array positioned along an opposite portion of the perimeter of the dome shaped housing from the first light array.

9. The light assembly according to claim 8, wherein the first light array and the second light array include a viewing angle between about 5 to 20 degrees and more particularly between about 8 to 15 degrees.

10. The light assembly according to claim 19, wherein the at least one light includes a viewing angle between about 120 to 160 degrees and more particularly about 140 degrees.

11. A light assembly to be selectively attached to a pad member comprising:
a dome shaped housing including a gripping surface;
at least one light disposed within the dome shaped housing; and
a base attached to the dome shaped housing, the base selectively attachable to a pad member, wherein the base includes a plurality of lugs extending from a perimeter of the base and the plurality of lugs are selectively attachable with a plurality of attachment members that extend from the pad member.

12. The light assembly according to claim 11, wherein the attachment member includes a biasing member having a self-locating detent configured to engage with a self-locating recess positioned on at least one lug of the base to align and attach the pad member to the light assembly.

13. The light assembly according to claim 11, wherein the pad member includes a shaped protrusion configured to be received within an annular recessed portion of the light assembly.

14. The light assembly according to claim 11, wherein one of the pad member and the base includes a magnet such that the base is magnetically attachable to the pad member.

15. The light assembly according to claim 11, wherein the base includes a swivel hook configured to pivot relative the base and be stowed within an annular recessed portion of the base.

16. The light assembly according to claim 11, wherein the pad member is attachable to a work surface.

17. The light assembly according to claim 11, wherein the dome shaped housing includes a lens cover for a hazard warning light wherein the hazard warning light includes a light array positioned along a portion of the perimeter of the dome shaped housing in alignment with the lens cover.

18. The light assembly according to claim 17, wherein the light array includes a viewing angle between about 5 to 20 degrees and more particularly between about 8 to 15 degrees.

19. The light assembly according to claim 11, wherein at least one light is positioned along a top of the dome-shaped housing, the dome shaped housing includes a depression that surrounds the at least one light.

20. The light assembly according to claim 19, wherein the at least one light includes a viewing angle between about 120 to 160 degrees and more particularly about 140 degrees.
